(19) United States
(12) Patent Application Publication
(10) Pub. No.: US 2026/0329100 A1
(43) Pub. Date: Oct. 22, 2026

(54) OPTICAL DEVICE

(71) Applicant: HIMAX TECHNOLOGIES LIMITED, Tainan City (TW)

(72) Inventors: Yun Lien HSIAO, Tainan City (TW); Yu-Ching CHENG, Tainan City (TW); Meng-Ko TSAI, Tainan City (TW); Ming-Shu HSIAO, Tainan City (TW)

(21) Appl. No.: 19/079,433

(22) Filed: Mar. 13, 2025

(51) Int. Cl. G02B 27/10; G02B 27/14

(52) U.S. Cl. CPC G02B 27/1006; G02B 27/146

(57) ABSTRACT

The optical device includes a stack of N optical transparent layers, in which N is an integer greater than or equal to three, plural optical band-pass filters, and plural first optical reflectors. The optical band-pass filters is sandwiched by adjacent ones of the N transparent optical layers. The first optical reflectors respectively are disposed on upper surfaces of an uppermost one to a second lowermost one of the N optical transparent layers.

### BACKGROUND

### Technical Field

The present disclosure relates to an optical device, and more particularly to an optical device having separated optical band-pass filters.

### Description of Related Art

In recent years, with the continuous development and demand of the optical communication industry, high-capacity fiber optic communication systems have become a trend. Therefore, it is necessary to develop high-precision optical components that can simultaneously output plural different wavelengths.

### SUMMARY

In one aspect of the present disclosure, an optical device is provided. The optical device may adopt a stack structure to make the band-pass filters and reflection mirrors may be fabricated in the stack structure by simple semiconductor processes, and bandwidths and a number of the band-pass filters in each layer of the stack structure and a number of reflection mirrors may be respectively designed according to functional requirements, thus reducing process complexity and improving design freedom, in which the band-pass filters of the optical device are separated from each other. Furthermore, by a light path formed by a combination of the reflection mirrors and band-pass filters in the stack structure, distances of output lights may be reduced to produce denser the output lights. In addition, the number of layers and the thickness of each layer of the stack structure may be easily designed and fabricated as long as parameters of an incident angle of an incident light, a pitch of a target sensor, and number of required output lights are obtained. Therefore, the optical device may have advantages such as reduction of process difficulty, higher design freedom and easy to increase the number of light outputs, while producing denser the output lights.

According to some embodiments of the present disclosure, an optical device is provided. The optical device includes a stack of N optical transparent layers, in which N is an integer greater than or equal to three, plural optical band-pass filters, and plural first optical reflectors. The optical band-pass filters are sandwiched by adjacent ones of the N transparent optical layers. The first optical reflectors respectively are disposed on upper surfaces of an uppermost one to a second lowermost one of the N optical transparent layers.

According to some embodiments of the present disclosure, the optical device further includes a second optical reflector. The second optical reflector is disposed on the upper surface of the uppermost one of the N optical transparent layers.

According to some embodiments of the present disclosure, the N optical transparent layers include a first optical transparent layer, a second optical transparent layer, and a third optical transparent layer that are stacked in sequence.

According to some embodiments of the present disclosure, a thickness of the second optical transparent layer is substantially the same as a thickness of the first transparent optical layer.

According to some embodiments of the present disclosure, a thickness of the third optical transparent layer is greater than the thickness of the first transparent optical layer.

According to some embodiments of the present disclosure, a number of the optical band-pass filters sandwiched by the second and third optical transparent layers is less than a number of the optical band-pass filters sandwiched by the first and second optical transparent layers.

According to some embodiments of the present disclosure, a bandwidth of the optical band-pass filters sandwiched by the second and third optical transparent layers is greater than a bandwidth of the optical band-pass filters sandwiched by the first and second optical transparent layers.

According to some embodiments of the present disclosure, at least one of the first optical reflectors is overlapped with another one of the first optical reflectors in a normal direction of the optical device.

According to some embodiments of the present disclosure, the optical band-pass filters are spaced apart from the first optical reflectors by the N optical transparent layer.

According to some embodiments of the present disclosure, a distance between one of the optical band-pass filters and one of the first optical reflectors is less than a distance between two of the first optical reflectors.

According to some embodiments of the present disclosure, the N optical transparent layers further comprise a transparent polymer layer disposed in one of the N optical transparent layers.

According to some embodiments of the present disclosure, a refractive index of the transparent polymer layer is the same as a refractive index of the one of the N optical transparent layers.

According to some embodiments of the present disclosure, a thickness of the transparent polymer layer is less than a thickness of the one of the N optical transparent layers.

According to some embodiments of the present disclosure, a number of the optical band-pass filters sandwiched by first and second lowermost ones of the N optical transparent layers is odd-numbered.

According to some embodiments of the present disclosure, a distance between two of the first optical reflectors is the same as a distance between two of the optical band-pass filters.

### BRIEF DESCRIPTION OF THE DRAWINGS

FIG. 1A is a schematic diagram of an optical device in accordance with some embodiments of the present disclosure.

FIGS. 1B and 1C are a schematic diagram of an optical path of the optical device in FIG. 1A.

FIG. 2A is a schematic diagram of an optical device in accordance with some embodiments of the present disclosure.

FIG. 2B is a schematic diagram of an optical path of the optical device in FIG. 2A.

FIG. 3A is a schematic diagram of an optical device in accordance with some embodiments of the present disclosure.

FIG. 3B is a schematic diagram of an optical path of the optical device in FIG. 3A.

FIG. 4A is a schematic diagram of an optical device in accordance with some embodiments of the present disclosure.

FIG. 4B is a schematic diagram of an optical path of the optical device in FIG. 4A.

### DETAILED DESCRIPTION

The embodiments of the present disclosure are discussed in detail below. However, it should be understood that the embodiments provide many applicable concepts that can be implemented in a wide variety of specific contexts. The embodiments discussed and disclosed are for illustrative purposes only and are not intended to limit the scope of the present disclosure. As used herein, the terms ‘first’, ‘second’, etc., do not specifically refer to order or sequence, but are intended only to distinguish components or operations that are described in the same technical terms.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. As used herein, the term “substantially” shall generally mean within 20 percent, or within 10 percent, or within 5 percent of a given value or range. Numerical quantities given herein are approximate, meaning that the term or “substantially” can be inferred if not expressly stated.

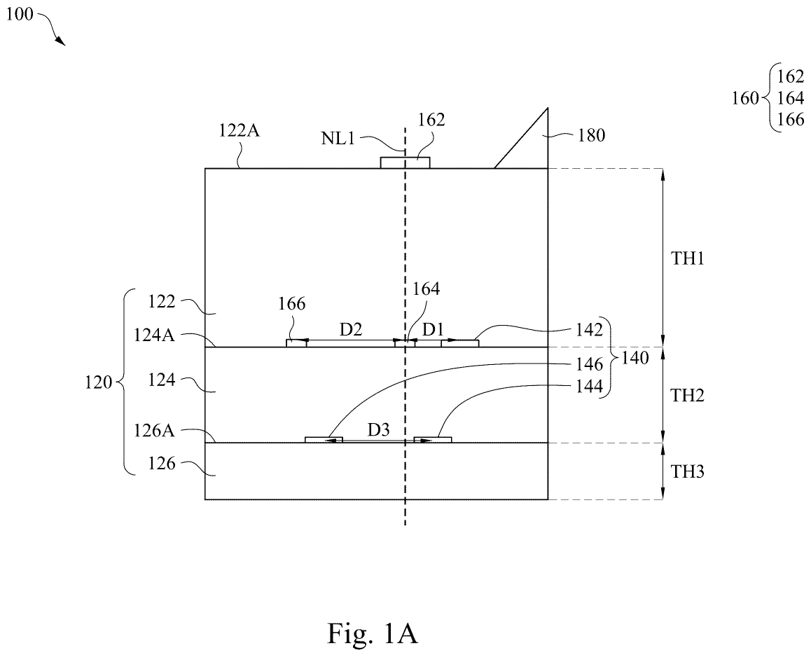

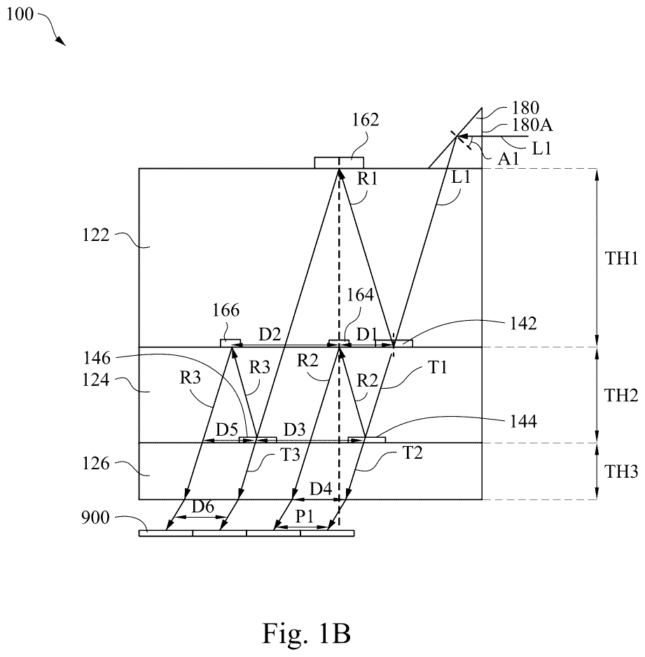

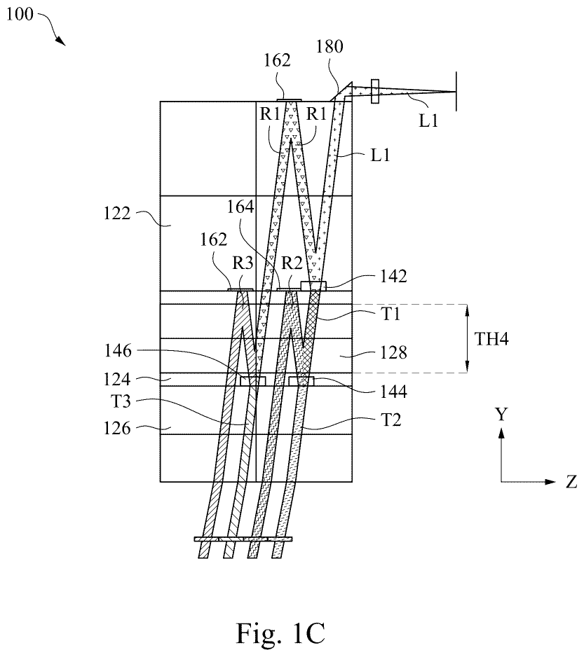

Referring to FIG. 1A, FIG. 1A is a schematic diagram of an optical device 100 in accordance with some embodiments of the present disclosure. In some embodiments, the optical device 100 may have a stack of N optical transparent layers 120, plural optical band-pass filters 140, plural optical reflectors 160 and optical reflector 180, in which N is an integer greater than or equal to three.

For example, in the present embodiment, the N optical transparent layers 120 may have optical transparent layers 122, 124 and 126. The optical transparent layers 122, 124 and 126 may adopt any appropriate material according to functional requirements, in which reflect indexes of the optical transparent layers 122, 124 and 126 may be substantially identical to each other. For example, in some embodiments, the optical transparent layers 122, 124 and 126 may be glass, similar materials, or a combination thereof. The thicknesses TH1, TH2 and TH3 of the optical transparent layers 122, 124 and 126 may be adjusted according to functional requirements. For example, in the present embodiment, the thickness TH1 of the optical transparent layer 122 is greater than the thicknesses TH2 and TH3 of the optical transparent layers 124 and 126, in which the thickness TH1 is twice of the thickness TH2 and the thicknesses TH2 and TH3 of the optical transparent layers 124 and 126 are identical to each other. In some other embodiments, the thickness TH2 of the optical transparent layers 124 is different from the thickness TH3 of the optical transparent layers 126, in which the thickness TH3 of the optical transparent layers 126 may be an arbitrary number, and may be adjusted according to a position of a sensor 900 (shown in FIG. 1B). Furthermore, the optical transparent layers 122, 124 and 126 may be stacked in sequence by a lamination process. For example, in the present embodiment, the optical transparent layer 124 is disposed on a top surface 126A of the optical transparent layer 126. The optical transparent layer 122 is disposed on a top surface 124A of the optical transparent layer 124.

In addition, in some embodiments, the N optical transparent layers 120 further include a transparent polymer layer 128 (shown in FIG. 1C) disposed in one of the N optical transparent layers 120, in which a refractive index of the transparent polymer layer 128 is the same as a refractive index of the one of the N optical transparent layers 120 and a thickness TH4 of the transparent polymer layer 128 is less than a thickness of the one of the N optical transparent layers. For example, in the preset embodiment, the transparent polymer layer 128 is disposed in the optical transparent layers 124, in which the thickness TH4 of the transparent polymer layer 128 is less than the thickness TH2 of the optical transparent layer 124. The transparent polymer layer 128 may be materials with the same refractive index of the optical transparent layer 124 such as a resin, similar materials, or a combination thereof. Therefore, the optical transparent layer 124 may achieve the same thickness with less material by utilizing the transparent polymer layer 128.

In some embodiments, the optical band-pass filters 140 are sandwiched by adjacent ones of the N optical transparent layers 120. For example, in the present embodiment, the optical band-pass filters 140 may include optical band-pass filters 142, 144 and 146. The optical band-pass filters 142, 144 and 146 may adopt any appropriate material according to functional requirements. For example, in some embodiments, the optical band-pass filters 142, 144 and 146 may be quartz, similar materials, or a combination thereof. The optical band-pass filter 142 may be disposed on the surface 124A of the optical transparent layer 124 by simple semiconductor processes such as photolithography process, in which the optical band-pass filter 142 may be sandwiched by the optical transparent layers 122 and 124. The optical band-pass filters 144 and 146 may be disposed on the surface 126A of the optical transparent layer 126 by simple semiconductor processes such as photolithography process, in which the optical band-pass filters 144 and 146 may be sandwiched by the optical transparent layers 124 and 126. Furthermore, bandwidths and number of the optical band-pass filters 142, 144 and 146 may be adjusted according to functional requirements. For example, in some embodiments, a number of the optical band-pass filter 142 is less than a number of the optical band-pass filters 144 and 146, in which a bandwidth of the optical band-pass filter 142 is greater than a bandwidth of the optical band-pass filters 144 and 146. Therefore, the optical device 100 may adopt less optical band-pass filters to produce denser the output lights.

In some embodiments, the optical reflectors 160 are respectively disposed on upper surfaces of an uppermost one to a second lowermost one of the N optical transparent layers 120, in which at least one of the optical reflectors 160 is overlapped with another one of the optical reflectors 160 in a normal direction NL1 of the optical device 100. For example, in the present embodiment, the optical reflectors 160 may include optical reflectors 162, 164 and 166. The optical reflectors 162, 164 and 166 may adopt any appropriate material according to functional requirements. For example, in some embodiments, the optical reflectors 162, 164 and 166 may be aluminum, similar materials, or a combination thereof. The optical reflector 162 may be disposed on a surface 122A of the optical transparent layer 122 by simple semiconductor processes such as photolithography process. The optical reflectors 164 and 166 may be disposed on the surface 124A of the optical transparent layer 124 by simple semiconductor processes such as photolithography process, in which the optical reflectors 164 and 166 may be sandwiched by the optical transparent layers 122 and 124, and the optical reflector 162 is overlapped with the optical reflector 164 in the normal direction NL1 of the optical device 100. In addition, positions of the optical reflectors 162, 164 and 166 may be adjusted according to functional requirements. For example, in the present embodiment, the optical reflectors 164 and 166 are spaced apart from each other by the optical transparent layer 122, and the optical reflector 164 is spaced apart from the optical band-pass filter 142 by the optical transparent layer 122, in which a distance D1 between the optical band-pass filter 142 and the optical reflector 164 is less than a distance D2 between the optical reflectors 164 and 166. For example, in the present embodiment, the distance D2 is twice of the distance D1. In addition, the optical band-pass filter 144 is spaced apart from the optical band-pass filter 144 by the optical transparent layer 124 and a distance D3 between the optical band-pass filters 142 and 146 is the same as the distance D2 between the optical reflectors 164 and 166.

In some embodiments, the optical reflector 180 is disposed on the upper surface of the uppermost one of the N optical transparent layers 120. For example, the optical reflector 180 is disposed on the surface 122A of the optical transparent layer 122, and spaced apart from the optical reflector 162 by a distance D4. The optical reflector 180 may adopt any appropriate material according to functional requirements. For example, in present embodiment, the optical reflector 180 may be the same materials as the optical reflectors 162, 164 and 166. In some embodiments, the optical reflector 180 may be different materials from the optical reflectors 162, 164 and 166 such as silver, similar materials, or a combination thereof. The optical reflector 180 may adopt any appropriate optical component that may reflect an incident light L1 (shown in FIGS. 1B and 1C) into the optical device 100. For example, in present embodiment, the optical reflector 180 may be a prism, similar optical component s, or a combination thereof.

Referring to FIGS. 1B and 1C, FIGS. 1B and 1C are a schematic diagram of an optical path of the optical device 100 in FIG. 1A. The incident light L1 is incident on a surface 180A of the optical reflector 180, and is reflected into the optical device 100 by the optical reflector 180, in which an incident angle A1 is related to a refractive index of the optical reflector 180. For example, a formula of the incident angle A1 is:

$$A 1 \leq 90 - {sin}^{- 1} ( \frac{1}{n} ) ,$$

where n is the refractive index of the optical reflector 180. The incident light L1 passes the optical band-pass filter 142 and is partially reflected as a reflected light R1 and partially transmitted as a transmitted light T1, in which the reflected light R1 is different from the transmitted light T1. For example, in the present embodiment, the reflected light R1 includes a green light and a blue light, and the transmitted light T1 includes a red light and a yellow light. The transmitted light T1 passes the optical band-pass filter 144 and is partially reflected as a reflected light R2 and partially transmitted as a transmitted light T2, in which the reflected light R2 is different from the transmitted light T2. For example, in the present embodiment, the reflected light R2 includes the yellow light, and the transmitted light T2 includes the red light. The transmitted light T2 is transmitted to a sensor 900, and the reflected light R2 is reflected and transmitted to the sensor 900 by the optical reflector 164, in which the distance D1 between the optical band-pass filter 142 and the optical reflector 164, and a distance D4 between the reflected light R2 and the transmitted light T2 are the same as a pitch P1 of the sensor 900.

The reflected light R1 is reflected to the optical band-pass filter 146 by the optical reflector 164. The reflected light R1 passes the optical band-pass filter 146 and is partially reflected as a reflected light R3 and partially transmitted as a transmitted light T3, in which the reflected light R3 is different from the transmitted light T3. For example, in the present embodiment, the reflected light R3 includes the green light, and the transmitted light T3 includes the blue light. The transmitted light T3 is transmitted to the sensor 900, and the reflected light R3 is reflected and transmitted to the sensor 900 by the optical reflector 166, in which the distance D5 between the optical band-pass filter 146 and the reflected light R3, and a distance D6 between the reflected light R3 and the transmitted light T3 are the same as the pitch P1 of the sensor 900. Therefore, the incident light L1 may be separated by the optical band-pass filters 142, 144 and 146 to produce denser the output lights, in which the bandwidths of the optical band-pass filters 142, 144 and 146 are different from each other.

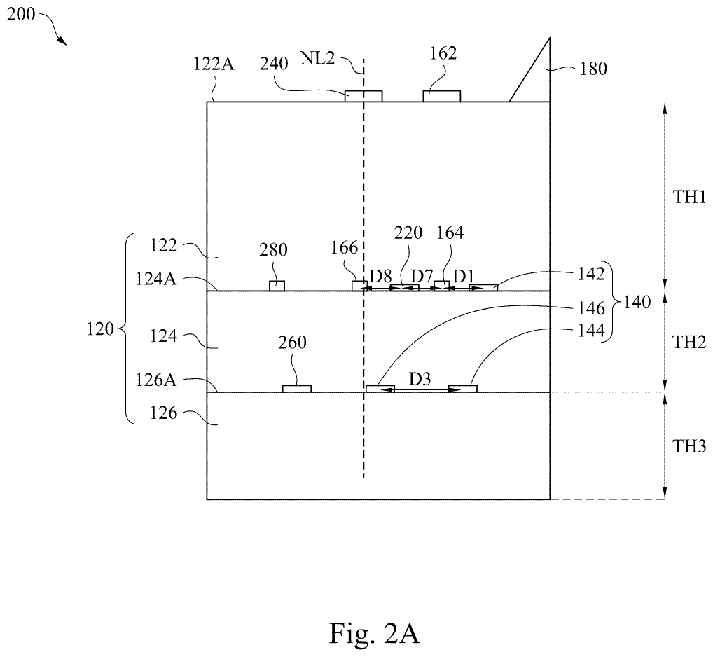

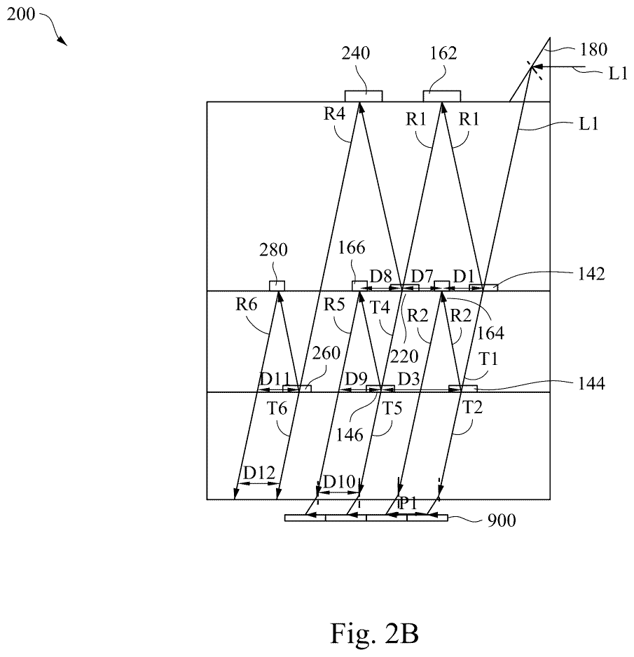

Referring to FIG. 2A, FIG. 2A is a schematic diagram of an optical device 200 in accordance with some embodiments of the present disclosure. The optical device 200 is similar to the optical device 100. The differences between the optical devices 100 and 200 is, in the optical device 200, the thickness TH3 of the optical transparent layer 124 of the optical device 200 is substantially the same as the thickness TH2 of the optical transparent layer 124 of the optical device 200. Furthermore, in the present embodiment, the optical device 200 further includes optical band-pass filters 220, 260, optical reflectors 240 and 280. The optical band-pass filter 220 may adopt the same materials as the optical band-pass filter 142. The optical band-pass filter 220 may be disposed on the surface 124A of the optical transparent layer 124 by simple semiconductor processes such as photolithography process, in which the optical band-pass filter 220 may be sandwiched by the optical transparent layers 122 and 124 and between the optical reflectors 164 and 166. A distance D7 between the optical band-pass filter 220 and the optical reflector 164, and a distance D8 between the optical band-pass filter 220 and the optical reflector 164 are the same as the pitch P1 of the sensor 900.

Furthermore, a bandwidth of the optical band-pass filter 220 is the same as the optical band-pass filter 142. The optical band-pass filter 260 may adopt the same materials as the optical band-pass filters 144 and 146. The optical band-pass filter 260 may be disposed on the surface 126A of the optical transparent layer 126 by simple semiconductor processes such as photolithography process, in which the optical band-pass filter 260 may be sandwiched by the optical transparent layers 124 and 126 and separated from the optical band-pass filters 144 and 146. Furthermore, a bandwidth of the optical band-pass filter 260 is the same as the optical band-pass filters 144 or 146.

In addition, a number of the optical band-pass filters sandwiched by the optical transparent layers 124 and 126 (e.g., the optical band-pass filters 144, 146 and 260) is odd-numbered, so that the optical device 100 may produce an odd number of output lights, not limited to an even number. The optical reflectors 240 and 280 may be respectively disposed on the surface 122A of the optical transparent layer 122 and the surface 124A of the optical transparent layer 124 by simple semiconductor processes such as photolithography process, in which the optical reflector 280 may be sandwiched by the optical transparent layers 122 and 124, and the optical reflector 240 is overlapped with the optical reflector 166 in a normal direction NL2 of the optical device 200.

Referring to FIG. 2B, FIG. 2B is a schematic diagram of an optical path of the optical device 200 in FIG. 2A. The optical path of the optical device 200 in FIG. 2B is similar to the optical path of the optical device 100 in FIG. 1B. The difference between the optical devices 100 and 200 is, in the optical device 200, the reflected light R1 passes the optical band-pass filter 220 and is partially reflected as a reflected light R4 and partially transmitted as a transmitted light T4, in which the reflected light R4 is different from the transmitted light T4. The transmitted light T4 passes the optical band-pass filter 146 and is partially reflected as a reflected light R5 and partially transmitted as a transmitted light T5, in which the reflected light R5 is different from the transmitted light T5. A distance D9 between the optical band-pass filter 146 and the reflected light R5 is the same as the pitch P1 of the sensor 900. The transmitted light T5 is transmitted to the sensor 900, and the reflected light R5 is reflected and transmitted to the sensor 900 by the optical reflector 166, in which the distance D5 between the optical band-pass filter 146 and the reflected light R5, and a distance D10 between the reflected light R5 and the transmitted light T5 are the same as the pitch P1 of the sensor 900.

The reflected light R4 is reflected to the optical band-pass filter 260 by the optical reflector 240. The reflected light R4 passes the optical band-pass filter 260 and is partially reflected as a reflected light R6 and partially transmitted as a transmitted light T6, in which the reflected light R6 is different from the transmitted light T6. The transmitted light T6 is transmitted to the sensor 900, and the reflected light R6 is reflected and transmitted to the sensor 900 by the optical reflector 280, in which the distance D11 between the optical band-pass filter 260 and the reflected light R6, and a distance D12 between the reflected light R6 and the transmitted light T6 are the same as the pitch P1 of the sensor 900. Therefore, the incident light L1 may be separated by the optical band-pass filters 142, 144, 146, 220, and 260 to produce an even number of the output lights, in which the bandwidths of the optical band-pass filters 220 and 260 are different from each other.

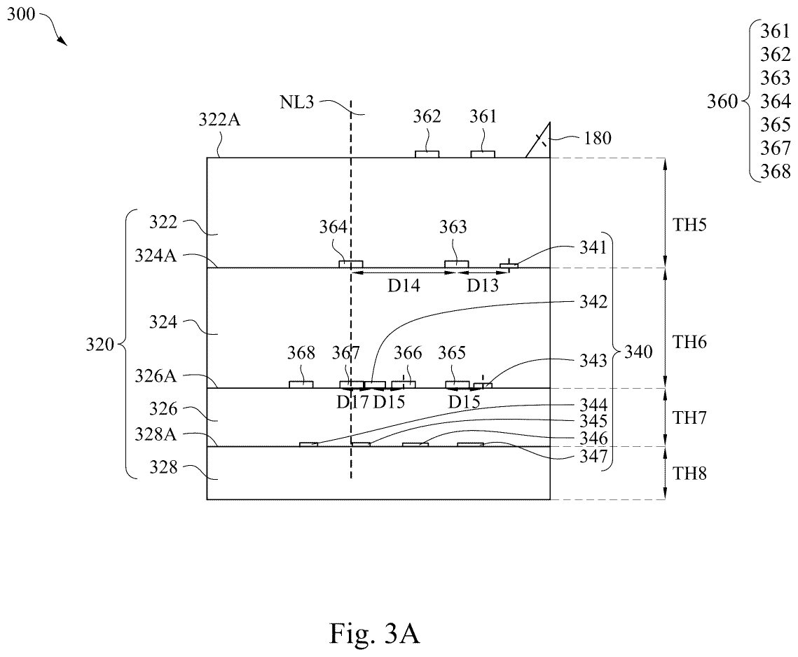

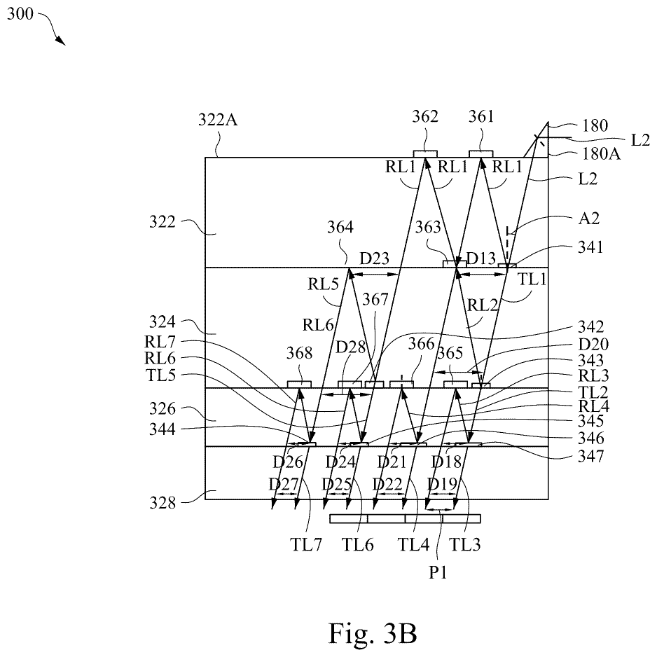

FIG. 3A is a schematic diagram of an optical device 300 in accordance with some embodiments of the present disclosure. The optical device 300 is similar to the optical devices 100 or 200. Differentness between the optical device 300 and 100 or 200 is: in the present embodiment, the N optical transparent layers 320 may have optical transparent layers 322, 324, 326, and 328. The thicknesses TH5, TH6, TH7, and TH8 of the optical transparent layers 322, 324, 326, and 328 may be adjusted according to functional requirements. For example, in the present embodiment, the thickness TH5 of the optical transparent layer 322 is the substantially the same as the thickness TH6 of the optical transparent layer 324, and the thickness TH5 of the optical transparent layer 322 is greater than the thicknesses TH7 and TH8 of the optical transparent layers 326 and 328, in which the thickness TH5 is twice of the thickness TH7. The thickness TH7 of the optical transparent layers 124 is different from the thickness TH3 of the optical transparent layers 126. For example, in the present embodiment, the thickness TH7 of the optical transparent layer 326 is:

$$TH 7 = \frac{P 1}{2} / tan θ ,$$

where θ is an incident angle A2 (shown in FIG. 3B) at which an incident light L2 (shown in FIG. 3B) is incident on an optical band-pass filter 341. The thickness TH8 of the optical transparent layer 328 may be an arbitrary number, and may be adjusted according to the position of the sensor 900 (shown in FIG. 3B). Furthermore, the optical transparent layers 322, 324,326 and 328 may be stacked in sequence by a lamination process. For example, in the present embodiment, the optical transparent layer 336 is disposed on a top surface 328A of the optical transparent layer 328. The optical transparent layer 324 is disposed on a top surface 326A of the optical transparent layer 326. The optical transparent layer 322 is disposed on a top surface 324A of the optical transparent layer 324.

In some embodiments, the optical band-pass filters 340 are sandwiched by adjacent ones of the N optical transparent layers 320. For example, in the present embodiment, the optical band-pass filters 340 may include optical band-pass filters 341, 342, 343, 344, 345, 346, and 347. The optical band-pass filter 341 may be disposed on the surface 324A of the optical transparent layer 324, in which the optical band-pass filter 341 may be sandwiched by the optical transparent layers 322 and 324. The optical band-pass filters 342 and 343 may be disposed on the surface 326A of the optical transparent layer 326, in which the optical band-pass filters 342 and 343 may be sandwiched by the optical transparent layers 324 and 326. The optical band-pass filters 344, 345, 346, and 347 may be disposed on the surface 328A of the optical transparent layer 328, in which the optical band-pass filters 344, 345, 346, and 347 may be sandwiched by the optical transparent layers 326 and 328.

Furthermore, bandwidths and number of the optical band-pass filters 341, 342, 343, 344, 345, 346, and 347 may be adjusted according to functional requirements. For example, in some embodiments, a number of the optical band-pass filter 341 is less than a number of the optical band-pass filters 342 and 343, and a number of the optical band-pass filters 344, 345, 346, and 347, in which a bandwidth of the optical band-pass filter 341 is greater than a bandwidth of the optical band-pass filters 342 and 343, and bandwidths of the optical band-pass filters 342 or 343 are greater than bandwidths of the optical band-pass filters 344, 345, 346, or 347. Therefore, the optical device 300 may adopt less optical band-pass filters to produce denser the output lights.

In the present embodiment, the optical reflectors 360 may include optical reflectors 361, 362, 363, 364, 365, 366, 367, and 368. The optical reflectors 361 and 362 may be disposed on a surface 322A of the optical transparent layer 322. The optical reflectors 363 and 364 may be disposed on the surface 324A of the optical transparent layer 324, in which the optical reflectors 364 and 366 may be sandwiched by the optical transparent layers 322 and 324. The optical reflectors 365, 366, 367, and 368 may be disposed on the surface 326A of the optical transparent layer 326, in which the optical reflectors 365, 366, 367, and 368 may be sandwiched by the optical transparent layers 324 and 326, in which the optical reflector 363 is overlapped with the optical reflector 366 in the normal direction NL3 of the optical device 300, and the optical reflector 364 is overlapped with the optical reflector 367 in the normal direction NL3 of the optical device 300.

In addition, a distance D13 between the optical band-pass filter 341 and the optical reflector 363 is less than a distance D14 between the optical reflectors 363 and 364. For example, in the present embodiment, the distance D14 is twice of the distance D13, in which the distance D13 is twice of the pitch P1 of the sensor 900 (shown in FIG. 3B). A distance D15 between the optical band-pass filter 343 and the optical reflector 365 is the same as the distance D16 between the optical band-pass filter 342 and the optical reflector 366 or the distance D17 between the optical band-pass filter 342 and the optical reflector 367, in which the distance D15 is the same as the pitch P1 of the sensor 900 (shown in FIG. 3B).

FIG. 3B is a schematic diagram of an optical path of the optical device 300 in FIG. 3A. The incident light L2 is incident on the surface 180A of the optical reflector 180, and is reflected into the optical device 300 by the optical reflector 180. The incident light L2 passes the optical band-pass filter 341 and is partially reflected as a reflected light RL1 and partially transmitted as a transmitted light TL1, in which the reflected light RL1 is different from the transmitted light TL1. The transmitted light TL1 passes the optical band-pass filter 343 and is partially reflected as a reflected light RL2 and partially transmitted as a transmitted light TL2, in which the reflected light RL2 is different from the transmitted light TL2. The transmitted light TL2 passes the optical band-pass filter 347 and is partially reflected as a reflected light RL3 and partially transmitted as a transmitted light TL3, in which the reflected light RL3 is different from the transmitted light TL3. The transmitted light T3 is transmitted to a sensor 900, and the reflected light RL3 is reflected and transmitted to the sensor 900 by the optical reflector 365, in which a distance D18 between the optical band-pass filter 347 and the reflected light RL3, and a distance D19 between the reflected light RL3 and the transmitted light TL3 are the same as a pitch P1 of the sensor 900.

The reflected light RL2 is reflected to the optical band-pass filter 346 by the optical reflector 363, in which a distance D20 between the optical band-pass filter 343 and the reflected light RL2 is twice of the pitch P1 of the sensor 900. The reflected light RL2 passes the optical band-pass filter 346 and is partially reflected as a reflected light RL4 and partially transmitted as a transmitted light TL4, in which the reflected light RL4 is different from the transmitted light TL4. The transmitted light TL4 is transmitted to the sensor 900, and the reflected light RL4 is reflected and transmitted to the sensor 900 by the optical reflector 366, in which the distance D21 between the optical band-pass filter 346 and the reflected light RL4, and a distance D22 between the reflected light RL4 and the transmitted light TL4 are the same as the pitch P1 of the sensor 900.

Furthermore, the reflected light RL1 is reflected to the optical band-pass filter 342 by the optical reflector 362, in which a distance D23 between the optical reflector 364 and the reflected light RL1 is twice of the pitch P1 of the sensor 900. The reflected light RL1 passes the optical band-pass filter 342, and is partially reflected as a reflected light RL5 and partially transmitted as a transmitted light TL5, in which the reflected light RL5 is different from the transmitted light TL5. The transmitted light TL5 passes the optical band-pass filter 345 and is partially reflected as a reflected light RL6 and partially transmitted as a transmitted light TL6, in which the reflected light RL6 is different from the transmitted light TL6. The transmitted light TL6 is transmitted to the sensor 900, and the reflected light RL6 is reflected and transmitted to the sensor 900 by the optical reflector 367, in which the distance D24 between the optical band-pass filter 345 and the reflected light RL6, and a distance D25 between the reflected light RL6 and the transmitted light TL6 are the same as the pitch P1 of the sensor 900.

The reflected light RL5 is reflected to the optical band-pass filter 344 by the optical reflector 364. The reflected light RL5 passes the optical band-pass filter 344 and is partially reflected as a reflected light RL7 and partially transmitted as a transmitted light TL7, in which the reflected light RL7 is different from the transmitted light TL7. The transmitted light TL7 is transmitted to the sensor 900, and the reflected light RL7 is reflected and transmitted to the sensor 900 by the optical reflector 368, in which the distance D26 between the optical band-pass filter 344 and the reflected light RL7, and a distance D27 between the reflected light RL7 and the transmitted light TL7 are the same as the pitch P1 of the sensor 900, in which a distance D28 between the optical band-pass filter 342 and the reflected light RL5 is twice of the distances D26 and D27.

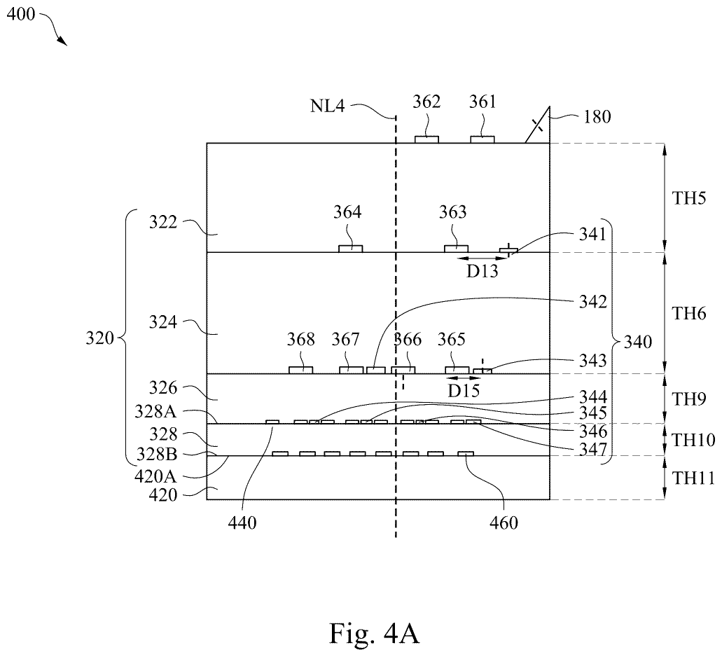

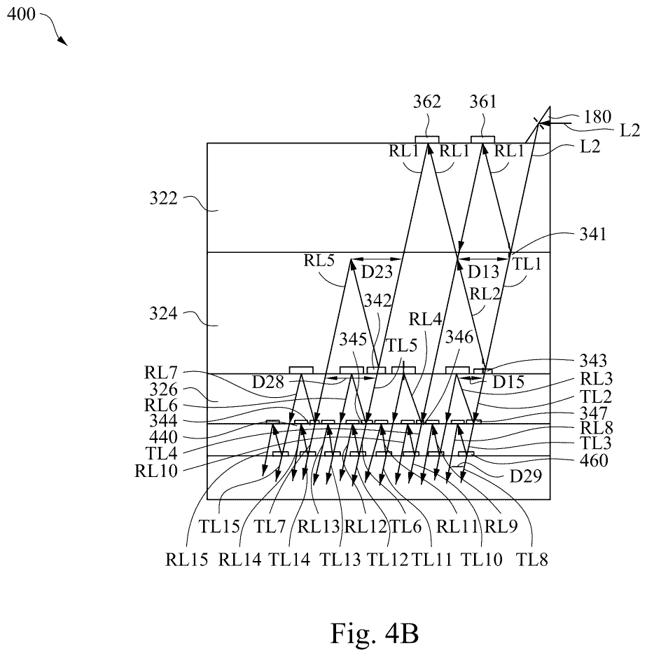

FIG. 4A is a schematic diagram of an optical device 400 in accordance with some embodiments of the present disclosure. The optical device 400 is similar to the optical device 300. The difference between the optical devices 300 and 400 is, the optical device 400 further includes an optical transparent layer 420, in which the optical transparent layer 420 is disposed on a surface 328B of the optical transparent layer 328. A thickness TH9 of the optical transparent layer 336 is twice of a thickness TH10 of the optical transparent layer 328. For example, in the present embodiment, the thickness TH10 of the optical transparent layer 328 is:

$$TH 10 = \frac{P 1}{2} / tan θ ,$$

where θ is an incident angle A2 (shown in FIG. 3B) at which an incident light L2 (shown in FIG. 3B) is incident on the optical band-pass filter 341. A thickness TH11 of the optical transparent layer 420 may be an arbitrary number, and may be adjusted according to the position of the sensor 900 (shown in FIG. 3B).

The optical device 400 further includes plural optical reflectors 440. The optical reflectors 440 may adopt any appropriate material according to functional requirements. For example, in some embodiments, the optical reflectors 440 may be aluminum, similar materials, or a combination thereof. The optical reflectors 440 may be disposed on the surface 328A of the optical transparent layer 328 by simple semiconductor processes such as photolithography process, in which the optical reflectors 440 may be sandwiched by the optical transparent layers 326 and 328, and the optical reflectors 365,367 and 368 respectively are overlapped with the optical reflectors 440 in a normal direction NL4 of the optical device 400. In addition, positions of the optical reflectors 440 may be adjusted according to functional requirements. For example, in the present embodiment, the optical reflectors 440 are spaced apart from each other by the optical transparent layer 326, and the optical reflectors 440 respectively are spaced apart from the optical band-pass filters 344, 345, 346, and 347 by the optical transparent layer 326.

Furthermore, the optical device 400 further includes plural optical band-pass filters 460. The optical band-pass filters 460 may adopt any appropriate material according to functional requirements. For example, in some embodiments, the optical band-pass filters 460 may be glass, similar materials, or a combination thereof. The optical band-pass filters 460 may be disposed on the surface 422A of the optical transparent layer 422 by simple semiconductor processes such as photolithography process, in which the optical band-pass filters 460 may be sandwiched by the optical transparent layers 420 and 328.

In addition, the distance D13 between the optical band-pass filter 341 and the optical reflector 363 is four tines of the pitch P1 of the sensor 900 (shown in FIG. 3B). The distance D15 between the optical band-pass filter 343 and the optical reflector 365 is the twice of the pitch P1 of the sensor 900 (shown in FIG. 3B). The distance D23 between the optical reflector 364 and the reflected light RL1 and the D28 between the optical band-pass filter 342 and the reflected light RL5 are four times of the pitch P1 of the sensor 900 (shown in FIG. 3B).

FIG. 4B is a schematic diagram of an optical path of the optical device 400 in FIG. 4A. The optical path of the optical device 200 in FIG. 2B is similar to the optical path of the optical device 100 in FIG. 1B. The difference between the optical devices 300 and 400 is, in the optical devices 400, the transmitted light TL3 passes one of the optical band-pass filters 460 and is partially reflected as a reflected light RL8 and partially transmitted as a transmitted light TL8, in which the reflected light RL8 is different from the transmitted light TL8. A distance D29 between the transmitted light TL8 and the reflected light RL8 is the same as the pitch P1 of the sensor 900. The reflected light RL3 passes the one of optical band-pass filter 460 and is partially reflected as a reflected light RL9 and partially transmitted as a transmitted light TL9, in which the reflected light RL9 is different from the transmitted light TL9. The transmitted light TL4 passes one of the optical band-pass filters 460 and is partially reflected as a reflected light RL10 and partially transmitted as a transmitted light TL10, in which the reflected light RL10 is different from the transmitted light TL10. The reflected light RL4 passes the one of optical band-pass filter 460 and is partially reflected as a reflected light RL11 and partially transmitted as a transmitted light TL11, in which the reflected light RL11 is different from the transmitted light TL11. The transmitted light TL6 passes one of the optical band-pass filters 460 and is partially reflected as a reflected light RL12 and partially transmitted as a transmitted light TL12, in which the reflected light RL12 is different from the transmitted light TL12. The reflected light RL6 passes the one of optical band-pass filter 460 and is partially reflected as a reflected light RL13 and partially transmitted as a transmitted light TL13, in which the reflected light RL13 is different from the transmitted light TL13. The transmitted light TL7 passes one of the optical band-pass filters 460 and is partially reflected as a reflected light RL14 and partially transmitted as a transmitted light TL14, in which the reflected light RL14 is different from the transmitted light TL14. The reflected light RL7 passes the one of optical band-pass filter 460 and is partially reflected as a reflected light RL15 and partially transmitted as a transmitted light TL15, in which the reflected light RL15 is different from the transmitted light TL15.

According to some embodiments of the present disclosure, an optical device is provided. The optical device may adopt a stack structure to make the band-pass filters and reflection mirrors may be fabricated in the stack structure by simple semiconductor processes, and bandwidths and number of the band-pass filters in each layer of the stack structure and number of reflection mirrors may be respectively designed according to functional requirements, thus reducing process complexity and improving design freedom, in which the band-pass filters of the optical device are separated from each other. Furthermore, by a light path formed by a combination of the reflection mirrors and band-pass filters in the stack structure, distances of output lights may be reduced to produce denser the output lights. In addition, the number of layers and the thickness of each layer of the stack structure may be easily designed and fabricated as long as parameters of an incident angle of an incident light, a pitch of a target sensor, and number of required output lights are obtained. Therefore, the optical device may advantages such as reduction of process difficulty, higher design freedom and easy to increase the number of light outputs, while producing denser the output lights.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An optical device, comprising:
a stack of N optical transparent layers, wherein N is an integer greater than or equal to three;
a plurality of optical band-pass filters sandwiched by adjacent ones of the N transparent optical layers; and
a plurality of first optical reflectors respectively disposed on upper surfaces of an uppermost one to a second lowermost one of the N optical transparent layers.

2. The optical device of claim 1, further comprising:
a second optical reflector disposed on the upper surface of the uppermost one of the N optical transparent layers.

3. The optical device of claim 1, wherein the N optical transparent layers comprise a first optical transparent layer, a second optical transparent layer, and a third optical transparent layer that are stacked in sequence.

4. The optical device of claim 3, wherein a thickness of the second optical transparent layer is substantially the same as a thickness of the first transparent optical layer.

5. The optical device of claim 3, wherein a thickness of the third optical transparent layer is greater than the thickness of the first transparent optical layer.

6. The optical device of claim 3, wherein a number of the optical band-pass filters sandwiched by the second and third optical transparent layers is less than a number of the optical band-pass filters sandwiched by the first and second optical transparent layers.

7. The optical device of claim 3, wherein a bandwidth of the optical band-pass filters sandwiched by the second and third optical transparent layers is greater than a bandwidth of the optical band-pass filters sandwiched by the first and second optical transparent layers.

8. The optical device of claim 1, wherein at least one of the first optical reflectors is overlapped with another one of the first optical reflectors in a normal direction of the optical device.

9. The optical device of claim 1, wherein the optical band-pass filters are spaced apart from the first optical reflectors by the N optical transparent layer.

10. The optical device of claim 1, wherein a distance between one of the optical band-pass filters and one of the first optical reflectors is less than a distance between two of the first optical reflectors.

11. The optical device of claim 1, wherein the N optical transparent layers further comprise a transparent polymer layer disposed in one of the N optical transparent layers.

12. The optical device of claim 11, wherein a refractive index of the transparent polymer layer is the same as a refractive index of the one of the N optical transparent layers.

13. The optical device of claim 11, wherein a thickness of the transparent polymer layer is less than a thickness of the one of the N optical transparent layers.

14. The optical device of claim 1, wherein a number of the optical band-pass filters sandwiched by first and second lowermost ones of the N optical transparent layers is odd-numbered.

15. The optical device of claim 1, wherein a distance between two of the first optical reflectors is the same as a distance between two of the optical band-pass filters.
